(19) United States
(12) Patent Application Publication
(10) Pub. No.: US 2017/0233300 A1
(43) Pub. Date: Aug. 17, 2017

(54) Additive Manufacturing of Polymer Derived Ceramics

(71) Applicant: Rishi Raj, Boulder, CO (US)

(72) Inventor: Rishi Raj, Boulder, CO (US)

(73) Assignee: American Manufacturing, Inc., Bouder, CO (US)

(21) Appl. No.: 15/042,992

(22) Filed: Feb. 12, 2016

(51) Int. Cl. C04B 41/83; C04B 35/626; C23C 26/00; B05D 3/02; C09D 183/16; B05D 7/24

(52) U.S. Cl. CPC C04B 41/83; C09D 183/16; B05D 7/24; C23C 26/00; B05D 3/0263; C04B 35/6267

(57) ABSTRACT

A layer by layer additive manufacturing system from liquid polymers for producing dense and defect free polymer-derived ceramic bodies of a three dimensional architecture.

### RELATED APPLICATIONS

This application claims priority from U.S. Provisional Application No. 62/115,375 filed on Feb. 12, 2015, incorporated by reference herein in its entirety.

### STATEMENT REGARDING FEDERALLY SPONSORED RESEARCH

This invention was made with government support under grant number DMR-090708 awarded by the National Science Foundation. The government has certain rights in the invention.

### FIELD

The present invention discloses a rapid additive manufacturing method for producing crack-free bodies of polymer-ceramic hybrid materials from polymer precursors.

### BACKGROUND

Polymer derived ceramics are made from silicon-based organic precursors by pyrolysis wherein the polymer material is heated slowly over several hours until it converts into the inorganic ceramic material. The organic material shrinks significantly when it begins to transform into the ceramic. Therefore, very slow heating rates, of several hours are used to reduce the possibility for forming cracks during this curing process. There remains a need in the art for techniques that can produce the inorganic ceramic components quickly without the development of shrinkage cracks.

Ceramic matrix composites are needed for ultrahigh temperature components in next generation gas turbine engines. The composites are manufactured from ceramic fibers that are spun into preforms of a three-dimensional net-shape. Infiltration of the fiber preforms with a ceramic matrix is needed for successful development of the high temperature components. In the polymer-infiltration and pyrolysis (PIP) process the fiber preform is infiltrated with the liquid polymer precursor. The precursor is cured slowly over several hours to reduce the chance of forming shrinkage cracks. There is a need for alternative methods that can produce dense defect-free ceramic matrix composites quickly and reliably.

### SUMMARY

Provided herein are methods of additive manufacturing of polymer derived ceramics wherein thin layers of the polymer precursor are deposited repetitively to build up the ceramic body. Each layer is cured individually. The layers are so thin that they convert into the ceramic in a few seconds when heated with infrared radiation. Additionally, the layers, being thin, are free from cracks and defects. The layers can conform to the shape of the substrate on which they are grown to produce net-shape ceramic bodies of a three-dimensional architecture

In one embodiment of the method a preform of carbon fibers is infiltrated with the polymer derived ceramic by layer-by-layer additive manufacturing to produce a ceramic matrix composite. The cycle time for deposition for each layer is less than one minute. The thickness of each layer ranges from 1 nanometers to 500 nanometers. The liquid precursor wets the fiber surfaces, and, therefore is wicked into the entire fiber preform. In less than 80 cycles the fibers in the preform can be fully encased in the dense, defect-free polymer derived ceramic matrix.

In a second embodiment the ceramic matrix composites are produced from preforms of silicon carbide fibers. Fully dense ceramic matrix from polymers by the additive manufacturing method is produced in less than 80 cycles.

The mechanical performance of the ceramic matrix composites produced by the additive manufacturing method show enhanced tensile strength and ductility. The higher properties, relative to composites processed by the conventional polymer-infiltration and pyrolysis (PIP) process, are attributed to the dense and defect-free matrix produced by the additive method. The nature of the fiber-matrix interface created by the additive process is conducive to good mechanical behavior.

The layer-by-layer additive manufacturing method can be tailored to create graded matrix structures for the fiber composites. The layers closer to the surface can be constituted from ceramics that serve the function of environmental barrier coatings for components engineered for next generation ceramic gas turbine engines. Integrated designs of matrix and coatings become feasible to implement by the layer-by-layer additive manufacturing method.

The additive manufacturing method can be used to produce three dimensional ceramic bodies of a complex shape.

The additive manufacturing method can be used to produce protective ceramic coatings on metal substrates.

The additive manufacturing method can be used to produce protective and tribological coatings on ceramic substrates constituted from oxides of non-oxide ceramic materials.

### BRIEF DESCRIPTION OF THE DRAWINGS

FIG. 1 depicts the additive manufacturing scheme for polymer derived ceramics. The polymer precusror is deposited as a liquid film on the object. The film is dried, cross-linked and then pyrolyzed under the radiant heating lamp for a few seconds, cooled and then cycled again.

FIG. 2 depicts a mesh of graphite fiber (a) before, and (b) after one-cycle infiltration with the polymer derived ceramic by the additive manufacturing method. Most notable is the nearly perfect wetting of the carbon fibers by the ceramic film.

FIG. 3 depicts the stages of infiltration of fiber preforms. First individual fibers are coated by a thin film of SiCN (8-16 cycles). Next the interstitial spaces are filled (40 cycles), and finally the entire tow is becomes encased in the polymer derived ceramic constituted from silicon carbonitride.

FIG. 4 depicts micrographs of carbon fiber bundle with individual fibers coated with approximately 250 nm thick coating of SiCN. The coating was built with 8 cycles. (a) Micrograph of the surface of the composite. (b) Micrograph of the cross section of the fiber composite.

FIG. 5 depicts second stage (16 cycles) of infiltration where the polymer derived ceramic begins to fill the interstitial spaces between the fibers, as seen in the cross-sectional view in (b).

FIG. 6 depicts Raman spectra from uncoated and coated fibers. Note the slight shift of the G and D peaks to higher wave numbers from the coating. Also the relative strengthening of the peaks from 8 to 16 cycles confirms the pyrolysis of the polymer into the ceramic phase.

FIG. 7 depicts surface and cross-sectional views of the fiber minicomposite after 80 cycles with 1 wt % solution of the precursor. We note the pore-free filling of the matrix surrounding the fibers.

FIG. 8 depicts (a) surface of the fiber bundle prepared with 40 cycles of 1 wt % solution. (b) Completely infiltrated fiber bundle prepared with 40 cycles of 1 wt % solution followed by 20 cycles of 0.1 wt % solution, and further followed by 16 cycles of 0.01 wt % solution for a total of 76 cycles. The surface of the composite was crack free.

FIG. 9 depicts stress-strain results from tensile testing of the ceramic matrix composites.

FIG. 10 depicts fracture surfaces of the ceramic matrix composites showing fiber pull-out. Progressively less pull-out with cycles shows the desired level of interfacial bonding.

FIG. 11 depicts (a) FTIR absorption spectra for the polymer precursor, the uncoated SiC fibers, and the coated SiC fibers. (b) Raman spectra for the polymer precursor and the uncoated and coated SiC fiber specimens.

FIG. 12 depicts nanoscale coating achieved on SiC fibers after 16 cycles.

FIG. 13 depicts cross sections in (a) high magnifications and (b) in low magnifications of the composites infiltrated to different degrees. The average fiber diameter in the upper figures is 7.5 μm.

FIG. 14 depicts tensile test data for uncoated and coated fiber composites, and the fracture surfaces showing the fiber-pull in the 80 cycle specimen (on the bottom right).

### DETAILED DESCRIPTION

Polymer derived ceramics (PDCs) are a new genre of high temperature structural materials because they can perform at temperatures that are far above the temperature at which they are made [1]. Conventional ceramics are made by sintering; the sintering temperature is necessarily higher than the use temperature since both, sintering and creep, are controlled by the rate of chemical diffusion. PDCs instead are made from the chemical route where an organic transforms into a refractory amorphous ceramic by the removal of hydrogen at 800° C.-1000° C. These ceramics then show outstanding creep and oxidation behavior at temperatures up to 1500° C.

The conversion of a liquid polymer into a high performance ceramic presents new opportunities such as photolithography for the fabrication of ceramic parts to net shape for example MEMS [2,3]. Here we show that the polymer route can be adapted to additive manufacturing, thereby opening up new pathways for creating net-shape ceramic structures from polymers. We are able to create nanoscale layers repetitively but quickly, in just a second or so, to build up the desired shape. We call it additive manufacturing of PDCs by flash-pyrolysis. Nominally, the conversion of the polymer into a ceramic requires several hours to prevent the development of cracks, which arise from the large shrinkage that accompanies the conversion of the polymer into the ceramic. Flash pyrolysis overcomes the key barrier in the commercialization of these polymer derived materials, which is the several hours that is required in conventional processing of PDCs.

The genesis of polymer-derived ceramics (PDCs) may be traced to Yajima [4,5], who in the early seventies produced ceramic fibers of silicon carbide from carbosilane a silicon-based polymer. The underlying chemistry of the process is that the carbon atoms in the alkyl groups in the polymer are attached to silicon. When heated in the 700-1000° C. range the hydrocarbons dissociate to release hydrogen to the atmosphere, leaving behind carbon and silicon in the solid state, in the form of silicon carbide.

Later more complex polymer chemistries wherein the silicon atoms are attached not only to carbon but also to nitrogen [6,7] and to oxygen [7,8] led to amorphous ceramics with unusual resistance to creep [1], which has been attributed to a nanodomain network of graphene that lies within them [9]. These amorphous materials also bear good resistance to oxidation [10].

The key impediment to additive manufacturing of net-shapes from PDCs has been the very slow heating rates with a process period of about 10 h, which are required to preempt fissures in the ceramic caused by shrinkage, and to allow hydrogen as the polymer evolves into the ceramic phase, to escape [7]. For these reasons the infiltration of fiber preforms from the polymer route, by the process known as PIP or polymer-infiltration-pyrolysis has been difficult. In this process the preform is dipped into the polymer precursor and the structure is pyrolyzed over a period of several hours. Several cycles are used to gradually infiltrate the composite. However, the constraint from the fiber preform often leads to the evolution of shrinkage cracks in the matrix. The strength of the infiltrated composite can be just 60% of strength of the fiber preform on its own [11], although the strength has been shown to increase somewhat with the number of cycles [12].

The procedure described in this article overcomes the above shortcoming of the PIP process by a rapid additive-manufacturing approach. Its success is based upon two tenets: (a) three dimensional infiltration of the composite is achieved because of nearly perfect wetting of the fiber bundle by the polymer, and (b) ultrathin layers that are infiltrated into the fiber bundle can be pyrolyzed in about one second; we call it flash-pyrolysis; these layers are dense and defect free.

Two embodiments of the additive manufacturing by repetitive deposition of nanometer scale coatings of the ceramic, polymer derived ceramic are presented. The cycle time for deposition of each layer by flash pyrolysis is reduced to about one second. Repetitive deposition of nanometer scale coatings of the ceramic, in this way, is employed to create defect free infiltrations of fiber preforms made from carbon-fibers (Example 1) and silicon carbide (Example 2). Excellent wetting properties of the polymer precursor permits three-dimensional, conformal coating through the three stages of infiltration: nanoscale coating of the single fibers, filling of interstitial spaces between the fibers, and a build up of the coating over the entire composite. The polymer derived matrix produced by the additive manufacturing process are dense. The strength of these ceramic matrix composites exceeds that of the un-infiltrated fiber preforms.

### EXAMPLES

### Example 1. Additive Manufacturing of Ceramics Enabled by Flash Pyrolysis of Polymer Precursors with Nanoscale Layers

The polymer-based route to ceramics is implemented into additive manufacturing by reducing the time for pyrolysis to about a second, called flash-pyrolysis. Repetitive deposition of nanometer scale coatings of the ceramic, in this way, is employed to create defect free infiltrations of carbon fiber composites. The mechanical strength of the fibers is retained in the composite. Excellent wetting properties of the polymer precursor permits three-dimensional, conformal coating through the three stages of infiltration: nanoscale coating of the single fibers, filling of interstitial spaces between the fibers, and a build up of the coating over the entire composite. The flash-pyrolysis method enables a new genre of polymer-derived ceramics made into net-shape by this unusual method of additive manufacturing.

### Introduction

Polymer derived ceramics (PDCs) are a new genre of high temperature structural materials because they can perform at temperatures that are far above the temperature at which they are made [1]. Conventional ceramics are made by sintering; the sintering temperature is necessarily higher than the use temperature since both, sintering and creep, are controlled by the rate of chemical diffusion. PDCs instead are made from the chemical route where an organic transforms into a refractory amorphous ceramic by the removal of hydrogen at 800° C.-1000° C. These ceramics then show outstanding creep and oxidation behavior at temperatures up to 1500° C.

The conversion of a liquid polymer into a high performance ceramic presents new opportunities such as photolithography for the fabrication of ceramic parts to net shape for example MEMS [2,3]. In this embodiment it is shown that the polymer route can be adapted to additive manufacturing, thereby opening up new pathways for creating net-shape ceramic structures from polymers. It is further demonstrated that nanoscale layers can be produced repetitively, and quickly, in just a second or so, to build up the desired shape. The rapid conversion is called flash pyrolysis. Nominally, the conversion of the polymer into a ceramic requires several hours to prevent the development of cracks. Flash pyrolysis overcomes the key barrier in the commercialization of these polymer derived materials, by significantly reducing the time for the fabrication of ceramics from PDCs.

The key impediment to producing net-shapes from PDCs has been the very slow heating rates with a process period of about 10 h, which are required to preempt fissures in the ceramic caused by shrinkage, and to allow hydrogen as the polymer evolves into the ceramic phase, to escape [7]. For these reasons the infiltration of fiber preforms from the polymer route, by the process known as PIP or polymer-infiltration-pyrolysis has been difficult. In this process the preform is dipped into the polymer precursor and the structure is pyrolyzed over a period of several hours. Several cycles are used to gradually infiltrate the composite. However, the constraint from the fiber preform often leads to the evolution of cracks in the matrix. The strength of the infiltrated composite can be just 60% of strength of the fiber preform on its own [11].

The procedure described in this embodiment overcomes the above short-coming of the PIP process by a rapid additive-manufacturing approach. Its success is based upon two tenets: (a) three dimensional infiltration of the composite is achieved because of nearly perfect wetting of the fiber bundle by the polymer, and (b) ultrathin layers that are infiltrated into the fiber bundle can be pyrolyzed in about one second; we call it flash-pyrolysis.

In this embodiment it is shown that the tensile strength of the composite is enhanced by the infiltration.

### Methods

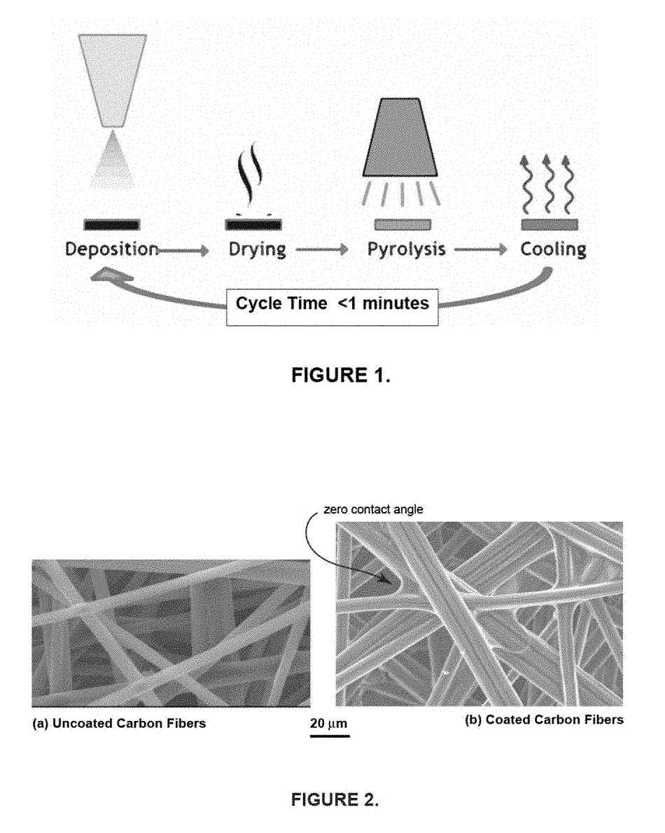

The embodiment of the manufacturing method is sketched in FIG. 1. Each cycle consists of four steps. (i) The deposition of the liquid precursor solution on the substrate. (ii) Drying the liquid to evaporate the solvent. (iii) Pyrolysis of the polymer film with an infrared radiation heater. (iv) Cooling the sample and return to the first step.

The substrate for depositing the polymer film can be a fiber preform, a metal, a ceramic or a polymer. The polymer precursor can be constituted from any combination of Si, C, N, O as well as transition metals such as Zr, Hf, and Ti. The precursor can be mixed with powders of a ceramic material such an oxide of a transition metal or a silicon based non-oxide for example silicon carbide. The solution is made with any organic solvent that does not react with the precursor to form new chemical products. The strength of the precursor in the solution can vary from 0.001 wt % up to 100 wt %. The drying temperature can vary from 50° C. to 450° C. Often the precursor is cross-linked during the drying step. The pyrolysis temperature varies from 600° C. to 1200° C.

In the present embodiment a carbon fiber preform was infiltrated with the polymer derived ceramic. The carbon fiber preform contained approximately 6000 fibers having a diameter of ˜10 μm, with a specific surface area of 0.23 m² g⁻¹. A preliminary heat treatment of carbon fibers was needed to remove the epoxy resin film on them. The fibers were placed within an alumina tube, and the furnace was heated to at a rate of 100° C. h⁻¹ in an argon atmosphere up to 1000° C. Batches of 100 mm long pieces of the fiber preforms were prepared in this way. Specimens for infiltration, each 30 mm long, were cut from these long pieces with metal scissors.

The polysilazane precursor was a yellow liquid with a density of 0.9-1.1 g cm⁻³ and a viscosity of 10-150 mPa s. The catalyst used to promote cross-linking was dicumyl peroxide and the solvent tetrahydrofuran (THF).

The success of the process depends on the excellent wetting characteristics of polymer precursor. Wettability was demonstrated by placing two drops of the precursor on the surface of graphite fiber paper, and pyrolyzing the composite. Micrographs of the uncoated graphite fibers in fiber mesh is shown in FIG. 2(a), that covered with a thin coating of the polymer derived, silicon-based ceramic coating is given in 2(b). Most noteworthy is the near zero contact angle of the coating on the fiber surface.

Polymeric precursor solution was prepared within a glove-box filled with an inert atmosphere. The solution contained 1 wt % polysilazane, although some with lower and some with higher content were also prepared to study the influence of concentration on the development of cracks. The dicumyl peroxide content was always held equal to one hundredth of the weight of the polysilazane precursor, with the remainder being the solvent THF. The chemicals were weighed and added to 100 ml brown glass bottle in the following order: dicumyl peroxide, polysilazane and THF. The mixture was stirred 1 min and stored in the glove box at room temperature.

The apparatus for additive manufacturing was assembled from in-house components. A schematic of the arrangement, placed within the glove box, is shown in FIG. 1. It consists of four steps. In the first step a specific volume of the liquid precursor solution was injected with a pipette at one end of the tow. Uniform percolation of the liquid to the dry end of the fiber preform ensured strong permeation by capillary action. In the next step the liquid was dried to evaporate the solvent while the precursor is cross-linked at 300-450° C. Next, the specimen was pyrolyzed under an infrared radiation furnace made from halogen lamps. The specimen was then cooled with a heat sink and returned to the injector for the next cycle. We have not made an attempt to optimize the cycle time, using about one minute for each of the four steps. However, with a more effective cooling device and better control of the per-cycle-thickness it would be possible to reduce the cycle time to 15 seconds or less.

Specimens were prepared with 8, 16, 40 and 80 cycles of infiltration. Unless otherwise stated the concentration of the precursor in the solution was held at 1 wt %. The injection volume per cycle in all experiments was kept constant at 5 μl. Higher concentrations and injection volumes led to cracks presumably because thicker coatings were more likely to develop fissures during pyrolysis. However, the determination of the optimum concentration and injection volume, those that were just below the threshold for cracking, was complicated by the fact that the total surface area of the composite decreases as infiltration increases, which has an influence of the thickness of the layer even if the injection volume is held constant. In these instances, a reduction in the concentration of the precursor in the solution was necessary to avoid cracks.

Samples for scanning electron microscopy were prepared by (a) mechanical polishing and (b) ion beam polishing. The coatings were characterized by Raman spectroscopy to ascertain that the polymer precursor had fully pyrolyzed. The ceramic phase contains graphene networks which yield the characteristic G and D peaks that serve as the signature of the polymer-derived ceramic phase [13].

The tensile properties of the composite were measured in a screw driven machine with a 500 N load cell. The uniaxial stress was estimated from the total cross section of the fibers in the uncoated specimens. The tensile tests were carried out at a displacement rate of approximately 1 cm min⁻¹. The gage length in the samples was 10 mm.

### Results

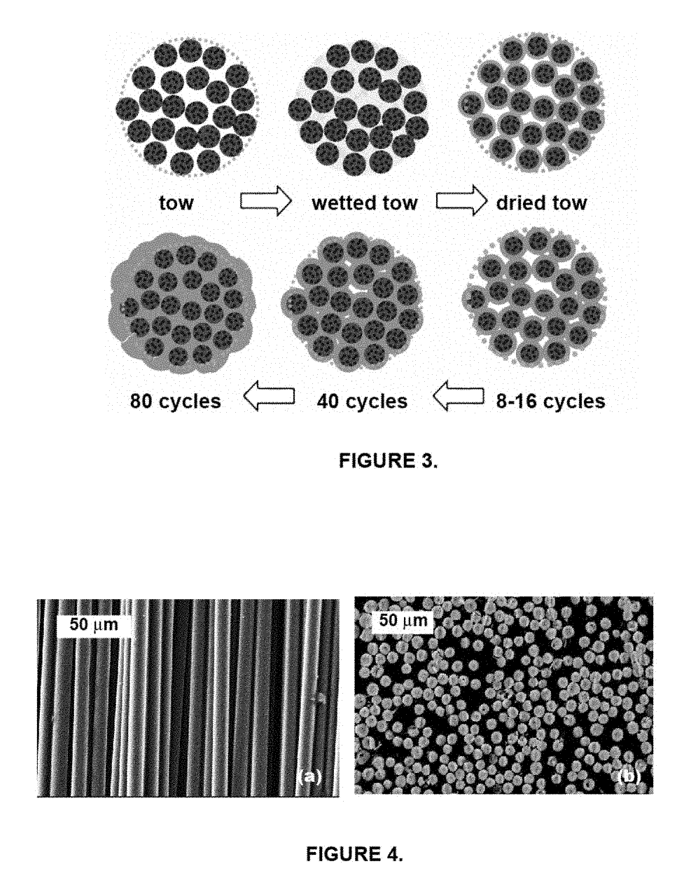

The wetting ability of the polymer precursor permits a study of three different stages of the additive infiltration process. In the first stage the individual fibers are coated with a thin ceramic layer. Next, the interstitial spaces between the fibers begin to fill, and finally the entire fiber tow is covered in uniform layers of the polymer derived SiCN. These stages are shown schematically in FIG. 3. Results from each of these stages are presented below.

Micrographs from specimens prepared with 8 cycles, which limited the coating mostly to individual fibers, are shown in FIG. 4. The surface view is shown in FIG. 4(a), and the cross-sectional view in (b). Note that the coatings in FIG. 4(a) are smooth, uniform, continuous, and entirely crack free.

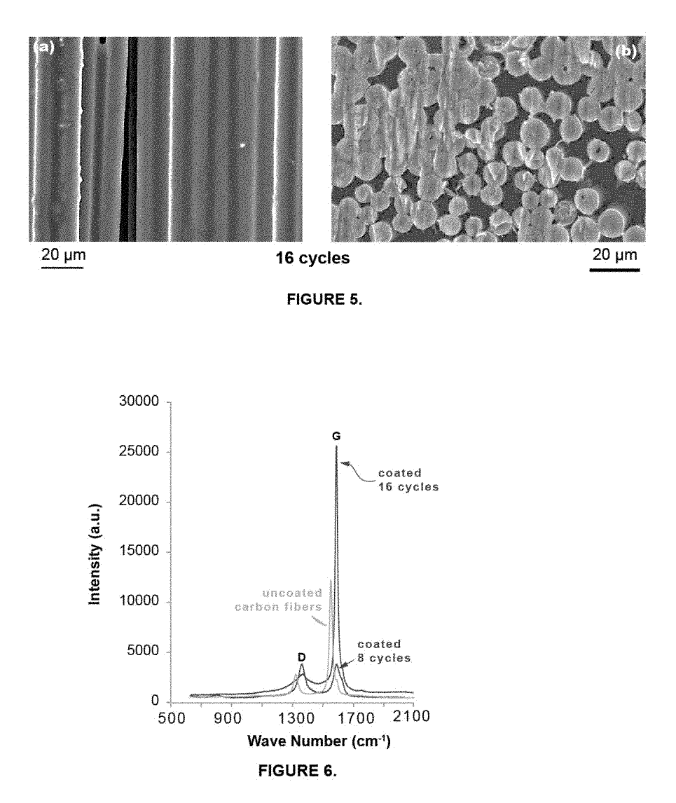

The cross sectional and longitudinal views of the fiber tow at 16 cycles are shown in FIG. 5. Note that the interstitial spaces between the fibers in FIG. 5(b) are now filling up, forming clusters of fibers that are encased within a dense matrix. The surface view in FIG. 5(a) shows a smooth surface and absence of cracks.

Pyrolysis of polysilazane yields a ceramic with signature D and G peaks of graphite which have also been predicted from a model for the structure of these amorphous ceramic materials [12]. Raman spectra obtained from the carbon composites in pristine uncoated condition and then coated with 8 cycle and 16 cycles are shown in FIG. 6. The graphite peaks are to be expected from uncoated fibers. However, the peaks shift slightly to a higher wavenumber and their intensity increases strongly when coated with 8 cycles to 16 cycles. At 8 cycles the peaks are indeed weaker than for the uncoated fiber as well as the D/G ratio is closer to unity, which may reflect the special nature of the interfaces between the thin SiCN coating and the graphite fiber. The strong peaks at 16-cycles assures that the polymer coating is indeed pyrolyzing into the ceramic phase.

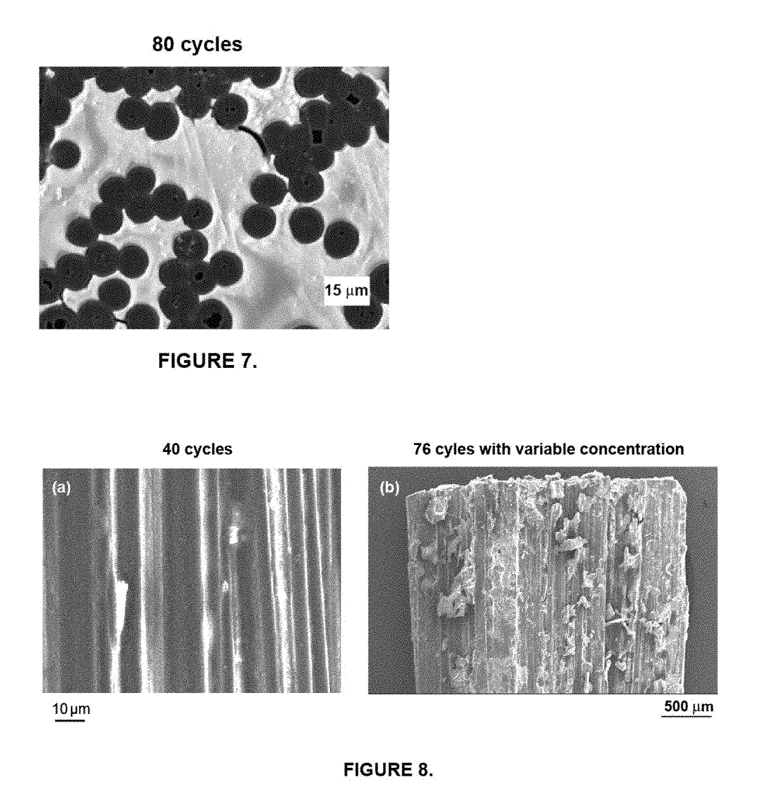

The micrographs for samples prepared with 80 cycles are given in FIG. 7. The micrograph confirms that SiCN forms a nearly dense matrix that encapsulates the carbon fibers. To repeat, the dense matrix is accomplished by (a) wetting of the inner surfaces in the composite by the polymer precursor, and (b) quick pyrolysis of very thin layers that are deposited repetitively. In this way the growth of bottlenecks that can prevent the polymer to seep within the composite can be avoided to a greater extent than in the case of the PIP process [11,12].

Micrographs of the crack free composite obtained after 40 cycles and after 76-80 cycles are shown in FIG. 8.

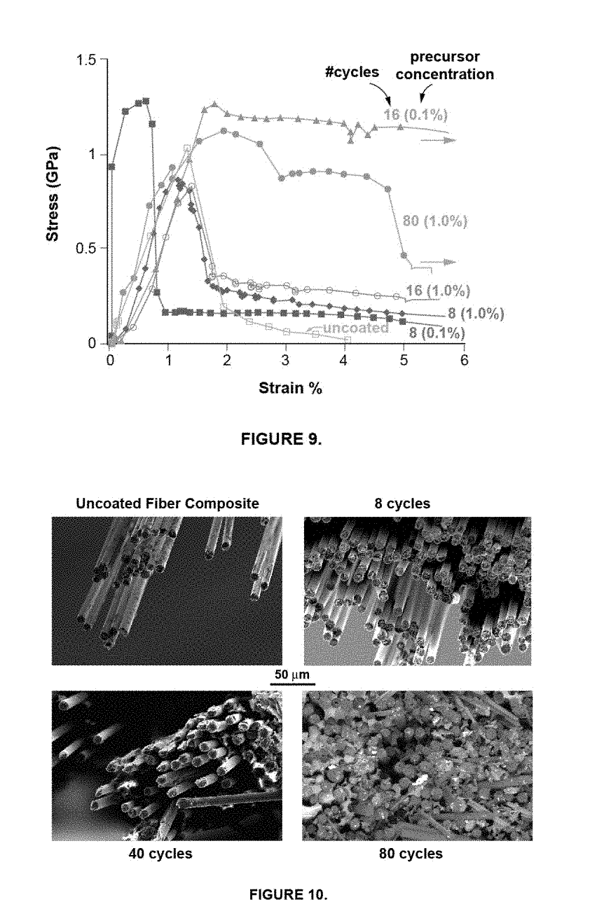

Mechanical Behavior of the composites from uniaxial tensile experiments is shown by the results in FIG. 9. In these experiments the ends of the specimens were gripped to a length of 10 mm on each side to prevent slippage. They were glued to paper which was then squeezed between serrated grips. This left a gage length of 10 mm. Most of the specimens broke within the gage length; those that did not were rejected. The strain was measured by dividing the grip extension by the gage length of 10 mm. These results have several features: (i) The ultimate tensile strength ranges from 0.9 GPa to 1.25 GPa with the infiltrated specimens consistently showing the higher strength levels. (ii) One group of specimens, which includes 8-cycle specimens, reach their peak strength near or below 1% strain and fracture soon after reaching the peak stress. With the exception of one specimen this group includes the uncoated sample and the samples prepared with 8-cycles where, as we have shown, mostly the individual fibers are coated without significant inter-particle bonding. These data show that the intrinsic strength of the fibers is not affected by the coating. (iii) The remaining two specimens, one with 16 cycles and the other with 80 cycles not only show a slightly higher ultimate tensile strength but also sustained strain before fracture. The 16-cycle experiment could be deformed to a large strain without a very significant drop in stress. The 80-cycle specimen dropped in stress at a strain of 5% but then continued to deform at this lower stress level to larger strains. This behavior is related to the sliding resistance of the fiber-matrix interface. The data suggest that the interfacial strength was optimized. If it had been too weak then prolonged strain to fracture would not have been possible. If it has been too strong then the specimen would have fractured at a stress below the strength of uncoated fiber bundle. Indeed micrographs of the fracture surfaces, in FIG. 10, show a large pull out for uncoated and 8-cycle specimens, and less so for specimens made with increasing number of cycles. Thus, it seems that the fracture behavior of these composites is midway between equal load-sharing and local load-sharing scenarios [14].

The large strains seen in some of the tensile tests are notable. They suggest that the interfaces between the fibers and the matrix continue to slide while supporting significant shear stress. However, the strain to fracture varies considerably, for example two 16-cycle samples, one prepared with 0.1% solution and the other with 1% solution show different behavior, the first showing a much larger strain that the other. To obtain a large strain, assuming the interface sliding mechanism applies, it would be necessary to have a continuous matrix that permeates the fiber bundle. In this sense the 80-cycle (1%) data where the matrix is indeed continuous are credible; they show a 5% tensile strain to fracture. The additively manufactured ceramic matrix composites, therefore, show good mechanical properties.

### DISCUSSION

The General Electric Company is poised to introduce ceramic matrix composites (CMCs) into the next generation gas turbines called the Leap engines. y are to be introduced into LEAP engines being manufactured by the General Electric Company. These composites are made from SiC fibers. The matrix is infiltrated with molten silicon which reacts with residual carbon to create a dense SiC matrix. The practical use temperature of these melt infiltrated ceramic matrix can be used at temperature of about 1200° C., that is, 200° C. below the melting point of silicon. The polymer derived matrix described in this embodiment would allow the composites to operate at temperatures as high as 1600° C.

The present embodiment opens up myriad new possibilities: new chemistries of the matrix phase, graded architectures that incorporate oxidation resistance coatings made, for example, from hafnium silicate [16,17], and robotic manufacturing for net-shape construction of turbine blades.

The present work where an additive, layer-by-layer method can be employed to build up a crack free matrix around the fiber preform, is a significant advance over the PIP method where the fiber preform is dip-coated and cured slowly over several hours. PIP requires several cycles, lasting more than a week are needed to finish the infiltration. PIP method does not eliminate defects in the form of large pores and microcracks [12,18]. In the embodiment dense matrix which is defect free is obtained. The method of the embodiment has great generality with respect to different kinds of fiber shapes, chemistries, and coatings.

The embodiment can be scaled up to fiber preforms of complex shapes. The wetting of the fiber surfaces is nearly perfect so that the liquid is wicked up into the entire fiber preform. Woven fiber preforms, that centimeters thick, can be processed by the additive manufacturing method.

The cycle time in the embodiment was about 1 minute although flash-pyrolysis was achieved in less than five seconds. The slowest step in the cycle, shown in FIG. 1, was the time required to cool the specimen down to ambient temperature before exercising the next cycle. With an automated system with efficient cooling mechanism a total cycle time of about 15 seconds is achieved.

### SUMMARY

Polymer derived ceramics made from silicon, carbon, nitrogen (and some amount of oxygen) in various compositions are a viable material for the matrix phase in ceramic matrix composites (CMCs). In the amorphous phase they show negligible creep [1], and their oxidation resistance is as good as that of ultrapure SiC [10]. Because of the open molecular network structure of these amorphous ceramics they have low coefficient of thermal expansion which can be expected to match that of the SiC fibers. While the present embodiment pertains to the silicon-nitrogen-carbon-oxygen system other silicon based precursors can be employed to produce a wide spectrum of chemistries from two or more elements deriving from this four element system. Metal oxides can be introduced into the precursor either in organic or as powders to create multilayer structures that not only serve as the matrix for the fiber composite but can also provide protection against aggressive environments at high temperatures.

In this embodiment the major barriers to the PIP process has been addressed. The barriers are the long curing times, and the frequent occurrence of cracks and inter-fiber voids that are left behind. These defects degrade the mechanical properties and are therefore not acceptable.

We show that rapidly repeated cycles with short pyrolysis times can be implemented if the deposition is carried out successively with layers, having a thickness of nanometers per layer. The nearly perfectly wetting behavior of the precursor with the fiber surface provides three-dimensional penetration to produce continuous and dense matrix phase. Processing cracks are completely avoided.

An obvious extension of the flash additive manufacturing with PDCs is that the precursors can be modified to create oxidation resistance coatings with various architectures by changing the precursor composition, as for example for coatings made from hafnia [16,17]. The continuum of graded architecture which can be created in this way is a special attribute of the additive process described in this embodiment.

### Example 2. Additive Manufacturing of Polymer Derived Ceramic Matrix for SIC Fiber Composites by Flash Pyrolysis of Nanoscale Polymer Films

This embodiment demonstrates the potential of manufacturing polymer-derived ceramic matrices for silicon-carbide fiber preforms by the additive manufacturing process. The thin liquid films, which naturally wet the fiber surfaces, are cross-linked and pyrolyzed in-situ into the silicon carbonitride ceramic in just a few seconds to yield defect free layers that are 1 nm to 500 nm thick. The infiltration is completed by repeating the cycles. A nearly fully dense and defect free polymer derived ceramic matrix could be obtained. Room temperature tensile tests show a tensile strength of ˜1200 MPa. Good matrix-fiber interface behavior is seen with pull-out character which is responsible for the ductility. The SiC fibers in the present embodiment were uncoated.

### Introduction

Ceramic matrix composites (CMCs) constituted from silicon-based ceramics are candidates for next generation high temperature applications, such as turbine blades, that can operate at temperatures that are significantly above the current ceiling set by single crystal superalloys. A first step in this direction has been taken by the General Electric Company who have introduced such composites made from SiC fibers embedded in a SiC matrix into gas turbines [15]. The matrix is produced by melt infiltration of silicon which reacts with carbon to produce a dense matrix of SiC. However, residual silicon limits the operating temperature of these composites to well below the melting point of silicon.

Composites that can operate above the melting point of silicon are possible with a matrix that is derived from silicon-based polymers. These ceramics have become to be generally known as polymer-derived ceramics or PDCs. Various polymer precursors such as polysilazanes, which yield silicon carbonitrides and polysiloxanes which leave behind silicon oxycarbides, offer expanded possibilities for tailoring the matrix for specific applications [19]. These polymers can be doped, for example with hafnium oxide which holds the promise of evolving into self-healing environmental barrier coatings of hafnium silicate [16,20]. These ternary, and higher order systems are amorphous, which has been confirmed to be the stable phase even at high temperatures [21,22]. Even more remarkable is the unusual creep resistance of these amorphous compounds at temperatures as high as 1500° C. [1,23].

The main issue with processing the matrix for CMCs from the silicon-based polymers is the large amount of shrinkage that accompanies hydrogen evolution and its transformation into the ceramic phase [24]. The ceramic is twice as dense as the polymer. As hydrogen evolves the material becomes increasingly refractory which leads to the formation of cracks. Thus the fiber preforms which have been infiltrated with the polymer must be heated slowly over a period of about a day. Several cycles are used to complete the infiltration of fiber preforms but cracks are difficult to avoid with the result that the composite often has a lower mechanical strength that the fibers by themselves. This process is known as PIP or polymer infiltration and pyrolysis [11,12].

In Example 1 it was demonstrated that additive manufacturing method where the matrix is built up with nanoscale layers of the polymer derived ceramic (PDC) can produce a dense matrix [25]. Each layer is typically 1 nm to 500 nm thick. Being so thin the layers can be pyrolyzed in mere seconds without forming defects. The special feature of this process is the excellent wetting behavior of the polymer which “wicks” into the fiber preform spreading the coating on all the fibers. The process was used to produce ceramic matrix composites of carbon fibers embedded in a silicon-carbon-nitrogen-oxygen matrix [25]. In this embodiment the successful application of the process to SiC fiber preforms is demonstrated.

### Methods

The silicon carbide fiber preforms were made from 1600 fibers; the average diameter of the fibers was 7.5 μm. But it can range from 1 μm to 100 μm. The fiber preforms were cut into pieces, 3 cm long and then infiltrated by the additive method. The polymer precursor for infiltration was a polysilazane. A catalyst, peroxide dicumyl, was added in a weight fraction of 1% to the polysilazane precursor to promote cross-linking. The mixture was then diluted with Tetrahydrofuran (THF) to obtain a 1 wt % solution of precursor for the additive deposition process. The additive manufacturing set-up is described in FIG. 1. Samples were prepared with 8, 16, 40 and 80 cycles. The samples were cut and the cross-section was polished with an ion beam and examined by scanning electron microscopy.

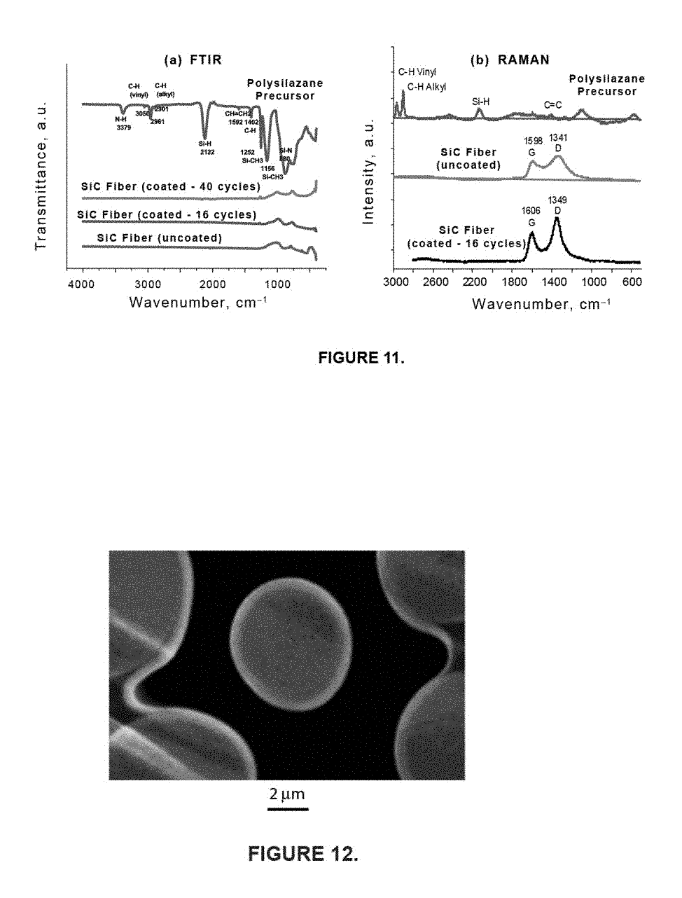

The evolution of the polymer-derived ceramic coating was examined by Raman Spectroscopy and FTIR, as shown in FIG. 11. The FTIR spectra showed the presence of the hydrogen bonds before pyrolysis and their absence after pyrolysis, confirming the validity of “flash pyrolysis”. On the other hand the Raman spectra showed the evolution of D and G peaks of carbon, a signature feature of PDCs [13].

Tensile tests were performed by the same method as described in Example 1.

### Results

An approximate measure of the thickness of the coating deposited per cycle was obtained from cross-sectional micrographs from specimens coated with sixteen cycles, since at this stage coatings on single fibers are discernible. An example is shown in FIG. 12. The coating is measured to be ˜500 nm, which gives a value of ˜30 nm thick coating deposited per cycle. Note that the coating remains adherent to the fiber surface despite a contraction of nearly 50% when the polymer converts into the ceramic. The coating has a smooth surface and is free from defects and micro-fractures.

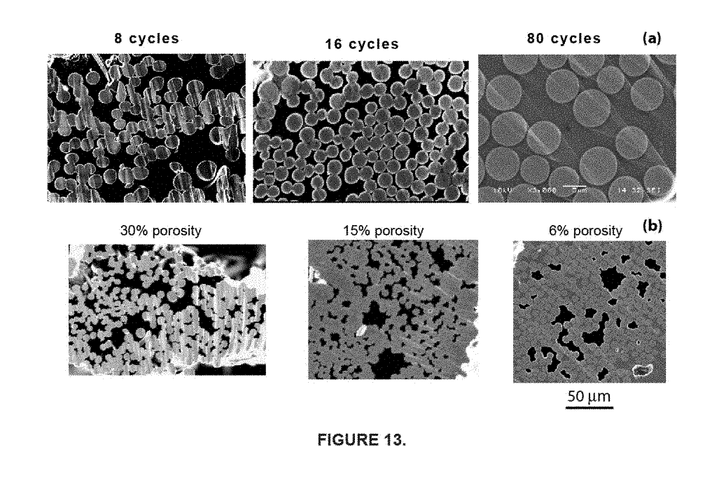

The cross-sections of the fiber bundles after 8, 16 and 80 cycles of deposition are shown in FIG. 13(a) at high magnification, and in 13(b) at low magnification. The infiltration goes through three stages. First the individual fibers are coated. Next the infiltration begins to bridge between the fibers, and finally the matrix begins to fill toward completion. The first stage is evident at 8 cycles, the incipient second stage at 16 cycles, and the full infiltration at 80 cycles. The lower magnification pictures shown in FIG. 13(b) show the porosity to reduce from 30% (8 cycles) to 15% (16-40 cycles) to 6% (40-80 cycles). The range of cycles for the porosity expresses some variability in the infiltration process.

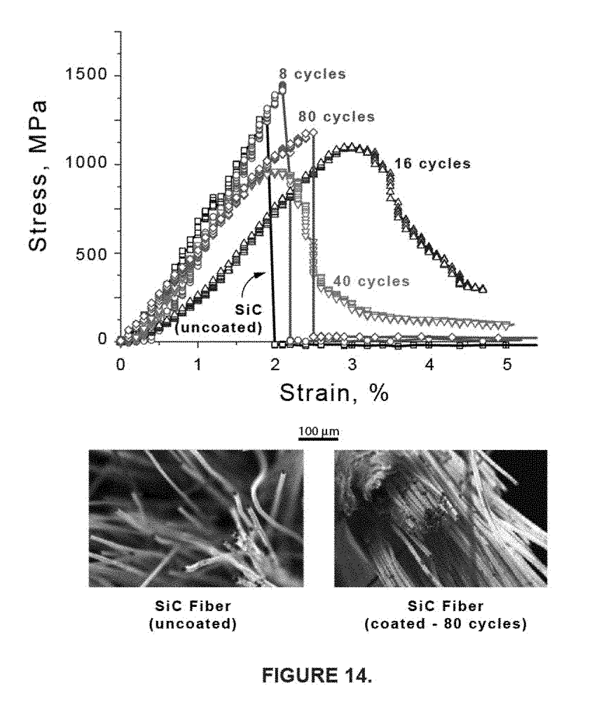

The results form tensile tests of specimens prepared with 8, 16, 40 and 80 cycles are shown in FIG. 14. The following features in these plots are noteworthy,

(i) The fracture behavior of the uncoated and 8 cycle specimens is the same, that is, fracture occurs abruptly, which is consistent with the absence of (lateral) bonding between the fibers since there is no matrix to promote “pull out” induced ductility. However, note that the fracture strength of the 8 cycle fibers is similar or perhaps somewhat higher than the uncoated fibers. This behavior shows that the coating, at the very least, does not degrade the tensile strength of the fibers. In PIP processed composites the strength is often lower than the strength of pristine fibers [11]. One important difference between the two processes is the chemistry of the precursor. In PIP experiments the precursor is carbosilane which yields crystalline silicon-carbide. Silicon carbide grown on silicon carbide fibers can nucleate new grains rendering the surface of the fibers to become roughened which can reduce their strength. Here the precursor yields an amorphous ternary compound of Si—C—N—O, which is unlikely to react with silicon-carbide substrates. Indeed Si—C—N—O has been shown to have low friction [13] which may be useful in the design of CMCs where sliding interfaces are desired.

(ii) The 16, 40 and 80 cycle experiments show “graceful” failure with extensive fiber pull out as shown in the micrographs in FIG. 14. The large degree of pull out seen in the 80 cycle specimen is consistent with the low friction that has been associated with Si—C—N—O [15]. If successful, then Si—C—N—O coating, which can be deposited rather easily and inexpensively, may be a substitute for the current BN coatings.

(iii) The ultimate tensile strength of the samples was in the range of 950 MPa to 1200 MPa, for specimens exposed to 16, 40 and 80 cycles. In comparison the 8 cycle specimen gave a tensile strength of 1450 MPa, and failure occurred abruptly. The strain to fracture of specimens where the fibers are bridged by the matrix (the 16, 40 and 80 cycle specimens) is definitely higher than for the unbridged fiber specimens (0 and 8 cycle). This difference highlights the significance of the interaction between fibers and the matrix via the fiber pull-out mechanism of fracture.

In this embodiment it is demonstrated that long processing cycles and the formation of defects that increase the cost and reduce the performance of CMCs made by the PIP process, can be overcome by an additive manufacturing protocol, where fast cycles and nanoscale depositions can shorten the pyrolysis time to just a few seconds. The polymer derived matrix is defect-free, the ultimate tensile strength is enhanced (relative to uncoated fibers), and fiber pull-out leads to large strains to failure.

The current experiments are carried out with a polysilazane precursor which produces a silicon carbonitride amorphous ceramic that is known to have low friction surfaces [13]. In contrast the PIP process is based upon polycarbosilane which produces silicon-carbide. It is postulated that the silicon-carbide evolving from the precursor can grow new grains on the silicon carbide fiber, thereby roughening the surface which can degrade the tensile strength of the fibers. In contrast the ternary silicon carbonitride is an amorphous ceramic with low frictional resistance, properties which can lead to the fiber pull-out mode of fracture. Thin Si—C—N—O coatings deposited by the additive manufacturing process can serve as an effective and low-cost substitute for boron nitride coatings for fibers.

### REFERENCES

1. An, L., Riedel, R., Konetschny, C., Kleebe, H., & Raj, R. (1998). Newtonian viscosity of amorphous silicon carbonitride at high temperature. Journal of the American Ceramic Society, 81(5), 1349-1352.
2. Liew, Li-Anne, et al. (2001): “Ceramic MEMS new materials, innovative processing and future applications.” American Ceramic Society Bulletin 80.5, 25-30.
3. Liew, Li-Anne, et al. (2001): “Fabrication of SiCN ceramic MEMS using injectable polymer-precursor technique.” Sensors and Actuators A: Physical 89.1, 64-70.
4. Yajima, Seishi, et al. (1976): “Development of a silicon carbide fibre with high tensile strength.” Nature, 683-685.
5. Yajima, S., et al. (1978): “Development of high tensile strength silicon carbide fibre using an organosilicon polymer precursor.” Nature, 525-527.
6. Riedel, R., Passing, G., Schönfelder, H., & Brook, R. J. (1992). Synthesis of dense silicon-based ceramics at low temperatures. Nature, 355(6362), 714-717.
7. Colombo, P., Mera, G., Riedel, R., & Soraru, G. D. (2010). Polymer-Derived Ceramics: 40 Years of Research and Innovation in Advanced Ceramics. Journal of the American Ceramic Society, 93(7), 1805-1837.
8. Zhang, H., & Pantano, C. G. (1990). Synthesis and characterization of silicon oxycarbide glasses. Journal of the American Ceramic Society, 73(4), 958-963.
9. Saha, A., Raj, R., & Williamson, D. L. (2006). A Model for the Nanodomains in Polymer-Derived SiCO. Journal of the American Ceramic Society, 89(7), 2188-2195.
10. Raj, R., An, L., Shah, S., Riedel, R., Fasel, C., & Kleebe, H. J. (2001). Oxidation kinetics of an amorphous silicon carbonitride ceramic. Journal of the American Ceramic Society, 84(8), 1803-1810.
11. Berbon, M., & Calabrese, M. (2002). Effect of 1600° C. heat treatment on C/SiC composites fabricated by polymer infiltration and pyrolysis with allylhydridopolycarbosilane. Journal of the American Ceramic Society, 85(7), 1891-1893.
12. Takeda, M., Kagawa, Y., Mitsuno, S., Imai, Y., & Ichikawa, H. (1999). Strength of a Hi-Nicalon™/Silicon-Carbide-Matrix Composite Fabricated by the Multiple Polymer Infiltration-Pyrolysis Process. Journal of the American Ceramic Society, 82(6), 1579-1581.
13. Cross, T., Raj, K., Prasad, S. V., Buchheit, T. E., & Tallant, D. R. (2006). Mechanical and Tribological Behavior of Polymer-Derived Ceramics Constituted from SiCxOyNz. Journal of the American Ceramic Society, 89(12), 3706-3714.
14. Phoenix, S. L., & Raj, R. (1992). Overview no. 100 Scalings in fracture probabilities for a brittle matrix fiber composite. Acta metallurgica et materialia, 40(11), 2813-2828.
15. Warwick, G. (2013). Betting on the future: tests suggest A320NEO engines will deliver on promises, but who will win in the long term?. Aviation Week & Space Technology, 175(22).
16. Terauds, K., Marshall, D. B., & Raj, R. (2013). Oxidation of Polymer-Derived HfSiCNO up to 1600° C. Journal of the American Ceramic Society, 96(4), 1278-1284.
17. Terauds, K., & Raj, R. (2013). Limits to the Stability of the Amorphous Nature of Polymer-Derived HfSiCNO Compounds. Journal of the American Ceramic Society, 96(7), 2117-2123.
18. Nannetti, C. A., Ortona, A., Pinto, D. A., & Riccardi, B. (2004). Manufacturing SiC-fiber-reinforced SiC matrix composites by improved CVI/slurry infiltration/polymer impregnation and pyrolysis. Journal of the American Ceramic Society, 87(7), 1205-1209.
19. E, Kroke, Li, E. Y., Konetschny, C. Lecomte, E., Fasel, C. & Riedel, R. (2000), “Silazane derived ceramics and related materials,” Materials Science and Engineering: R: Reports, 26(4), 97-199.
20. Terauds, K., Raj, R., & Kroll, P. (2014) “Ab inito and FTIR Studies of HfSiCNO Processed from the Polymer Route,” Journal of the American Ceramic Society, 97(3), 742-749.
21. Varga, T. et al. (2007) “Thermodynamically Stable SixOyCz Polymer□ Like Amorphous Ceramics,” Journal of the American Ceramic Society 90[10] 3213-3219.
22. Morcos, R. M. et al. (2008) “Thermodynamically Stable SiwCxNyOz Polymer□Like, Amorphous Ceramics Made from Organic Precursors,” Journal of the American Ceramic Society 91[7]: 2391-2393.
23. Riedel, R., Ruswisch, L. M., An, L., and Raj, R. (1998) “Amorphous silicoboron carbonitride ceramic with very high viscosity at temperatures above 1500 C.” Journal of the American Ceramic Society 81, no. 12: 3341-3344.
24. Sorarù, G. D., Pederiva, L. Latournerie, J., and R. Raj, R. (2002) “Pyrolysis kinetics for the conversion of a polymer into an amorphous silicon oxycarbide ceramic.” Journal of the American Ceramic Society 85, no. 9 (2002): 2181-2187.
25. Zoli, L., Sciti, D., Liew, L.-A., Terauds, K., Azarnoush, S, and R. (2015) “Additive Manufacturing of Ceramics Enabled by Flash Pyrolysis of Polymer Precursors with Nanoscale Layers.” Journal of the American Ceramic Society, online DOI: 10.1111/jace.13946.

1. An additive manufacturing system for layer-by-layer deposition of a liquid polymer, followed by fast in-situ conversion of a polymer precursor layer into a ceramic film on a substrate, comprising:
a spray station for depositing a thin layer of a liquid polymer solution on the substrate;
a heating station for cross linking the polymer;
a heater station for pyrolyzing the polymer into a ceramic material;
a cooling station to return the substrate to ambient temperature;
an x,y,z translation system for moving the substrate between these stations for layer-by-layer build up of the ceramic material into a net shape.

2. The additive manufacturing system of claim 1 is placed in its entirety within a chamber that is filled with an inert gas.

3. The additive manufacturing system of claim 1 wherein the spray station can deposit a volume of 1 μL to 750 μL of the polymer solution for every 1 cm² surface area of the fiber preform.

4. The additive manufacturing system of claim 1 wherein cross-linking station reaches a temperature ranging from 50° C. to 450° C.

5. The additive manufacturing system of claim 1 wherein the pyrolyzing station can heat treat the component at temperatures ranging from 700° C. to 1450° C.

6. The spray station of claim 3 wherein the polymer solution is constituted from 0.001 wt % to 100 wt % of an active polymer precursor in a solvent.

7. The polymer solution in claim 6 wherein the active polymer precursor is made from classes of polymers known as polysilazanes, or polysiloxanes or polycarbosilanes.

8. The polymer solution in claim 6 wherein the active polymer precursor is made from a mixture of polymers known as polysilazanes, polysiloxanes and carbosilanes.

9. The polymer solution in claim 6 wherein the active polymer precursor is further mixed with a class of organics known as metal-alkoxides.

10. The polymer solution in claim 6 wherein the active polymer precursor is further mixed with particles of ceramics constituted from oxides of a metal.

11. The polymer solution in claim 6 wherein the active polymer precursor is further mixed with particles of ceramics constituted from silicon, carbon, nitrogen and oxygen.

12. The polymer solution in claim 6 wherein the active polymer precursor is further mixed with particles of ceramics constituted from borides of a metal.

13. The additive manufacturing system of claim 1 wherein the substrate is in the shape of a porous preform made from ceramic fibers.

14. The substrate in claim 13 is constituted from fibers of silicon-based or metal-oxide based ceramic materials.

15. The system in claim 1 is used to deposit, in each cycle, a layer of a polymer derived ceramic material having a thickness ranging from 1 nm to 500 nm.

16. The system in claim 1 is employed to deposit 1 to 10,000 layers to complete the filling of a fiber preform with a ceramic matrix having a relative density ranging from 20% up to 100%.

17. The system in claim 1 is used to infiltrate fiber preforms having total thickness ranging from 0.1 mm to 5 cm.

18. The system in claim 1 is used to deposit a system of several layers of different compositions.

19. The system of layers in claim 18 wherein the layers are constituted from silicon oxycarbonitride and mixtures of silicon oxycarbonitrides and transition metal oxides.

20. The system of layers in claim 18 wherein the layers are constituted from mixtures of liquid polymers and powders of hafnium oxide, zirconium oxide and titanium oxide having a particle size ranging from 10 nm to 10 μm.

21. The system of layers in claim 18 wherein the layers contain volume fractions of the solid powders ranging from 1% to 60% by volume.

22. The additive manufacturing system in claim 1 is computer controlled with an embedded software to program the time-temperature sequence of each cycle in many different ways, as suitable for a certain system of ceramic layers.

23. The additive manufacturing system in claim 1 is used to fabricate ceramic bodies of complex three dimensional architecture.

24. The additive manufacturing system in claim 1 is used to produce coatings of a ceramic material on a metallic substrate.

25. The additive manufacturing system in claim 1 is used to produce coatings of a ceramic material on a substrate of another ceramic material.
